(19) United States
(12) Patent Application Publication
(10) Pub. No.: US 2015/0048535 A1
(43) Pub. Date: Feb. 19, 2015

(54) Method and Device for the Cooling of Foamed Polymeric Materials

(71) Applicant: Christian Schlummer, Winterthur (CH)

(72) Inventor: Christian Schlummer, Winterthur (CH)

(21) Appl. No.: 14/450,383

(22) Filed: Aug. 4, 2014

(30) Foreign Application Priority Data
Aug. 13, 2013 (EP) 13180279.5

(51) Int. Cl. B01J 19/00

(52) U.S. Cl. CPC B01J 19/0013
USPC 264/48; 425/88

(57) ABSTRACT

A method for cooling a foamed ribbon-shaped extrudate strand (3) is performed in a plant which comprises an extruder (8), a die (1), a vacuum cooling device (2) and a cooling drum. A polymer melt containing a blowing agent is produced in the extruder (8). The extrudate containing the blowing agent is guided to the die (1), whereby the die has an opening (7), through which a ribbon-shaped extrudate strand (3) is produced which foams in or after the die (1) to a foamed ribbon-shaped extrudate strand (13). The ribbon-shaped plastic foamed or foamable extrudate strand (13) is cooled first by a static vacuum cooling device (2, 25, 26), so as to obtain a precooled foamed ribbon-shaped extrudate strand (23) and the precooled foamed ribbon-shaped extrudate strand (23) is guided over a cooling drum (40, 41, 42). The precooled foamed ribbon-shaped extrudate strand (23) is in contact with the cooling drum over a wrap angle of at least 20°, such that the precooled foamed ribbon-shaped extrudate strand (23) is cooled.

### BACKGROUND OF THE INVENTION

The invention relates to a method for cooling of foamed planar extrudates such as plates and foils which is very efficient and leads to optimal surface qualities.

The foam extrusion is a specific method of extrusion, in which one or more blowing agents are metered to a polymer melt in an extruder and mixed to manufacture a foamed extrudate. As an alternative to chemical blowing agents, physical blowing agents are used for generating a cellular foam structure, due to the fact that they are more economic and do not form any residues in the polymer. Carbon dioxide, nitrogen, pentane, water and mixtures thereof are used as physical blowing agents. During a foaming process with a physical blowing agent, the blowing agent is brought into contact with the polymer melt under high pressure and mixed intensely. The blowing agent forms preferably a monophasic solution with the polymer melt under pressure and is brought into shape by a die, in particular in the shape of a plate or a foil. The die usually forms the exit opening for the polymer melt containing the blowing agent. During the extrusion process the blowing agent added to the polymer melt expands due to the pressure decrease in the die and forms a cellular foam structure.

Different optimized die configurations are known for foaming of flat extrudates, such as shown in document U.S. Pat. No. 6,383,425B1. Typically the discharge area of the nozzle is disposed with cooling bores to cool the foaming extrudate. Under a flat extrudate it is intended in the following text a flat extrudate strand which passes a slit-shaped die. Depending on the width of this slit, the ribbon-shaped extrudate strand is termed a foil or a plate. The thickness of the ribbon-shaped extrudate strand is fixed by the width of the slit at the discharge end of the nozzle. A thin and bendable ribbon-shaped extrudate strand of a thickness of typically 10 to 2000 μm is named a foil. A thicker, ribbon-shaped extrudate strand of a thickness of about 0.5 to 40 mm is named a plate, whereby the transitions are smooth.

The extrudate is cooled downstream of the nozzle to solidify the foam structure. A further cooling of foamed flat extrudates is typically performed by tempered drums. GB 1 264 852 describes a method to deposit a foamed flat extrudate on a single cooling drum. U.S. Pat. No. 3,855,376 discloses a method using a rotating pair of drums for cooling the flat extrudate leaving the nozzle. In the document EP 1 268 624 B1 a physical foaming method is shown, in which the flat extrudate is cooled in a roller mill with three tempered drums. In the document JP2001347560 A the extrudate leaving the nozzle of the extruder is cooled by a spray cooling device.

The surface quality of foamed and cooled flat extrudates is in a lot of cases unsatisfactory and worse as for unfoamed extrudates. The problem increases with an increasing degree of foaming, increasing cell size and a broad cell distribution. Due to the fact that a higher degree of foaming can be reached with physical blowing agents as opposed to chemical blowing agents and the foam structure being partially coarsely cellular, considerable surface problems, such as rough surfaces and wave shapes develop predominantly in products which are physically foamed.

If a single cooling drum is used for depositing the flat extrudate, only one side of the flat extrudate is cooled intensely. Furthermore the counter pressure of a corresponding counter drum is missing. If two cooling drums are used which are arranged opposite to another, a linear contact of the extrudate with the cooling surfaces results, whereby the contact time and the cooling power is reduced. The extrudate is guided through the two cooling drums arranged opposite to one another.

If three cooling drums are used, two consecutive wrap angles result, however the frontside and the backside of the extrudate are cooled in subsequent time periods, which may lead in particular to differing surface results in terms of roughness and degree of brilliance for foamed extrudates. The cooling effect of the cooling drums is reduced for foamed extrudates due to the fact that the formed foam cells act as an insulation. Further it is to be considered that a higher conveyor speed is obtained for foamed extrudates and consequently shorter contact times of the extrudate with the cooling surfaces for constant extruder throughput. In a lot of cases the discharge capacity is limited for foamed extrudates as the cooling capacity of the cooling drums acts as a limiting factor for the throughput.

A number of different methods and devices, as for instance disclosed in documents EP 0 925 900 (A1), U.S. Pat. No. 5,997,784 or DE 2 904 720 (A1), are known in which extrudates and in particular foamed extrudates are cooled in a chamber or in a calibration device operating under vacuum conditions.

Each configuration is provided with laterally closed chambers or laterally open plates which are arranged immediately after or in a distance to the die. A disadvantage of the cooling of flat extrudates in such devices and methods is, that very long units have to be built for a sufficient cooling effect or that the throughput and consequently the production capacity of the entire plant is very small. The danger of detachment of the extrudate from the surface of the cooling device exists with increasing length thereof due to the shrinkage of the extrudate occurring with progressing cooling, which leads to a substantial decrease of the cooling capacity. In addition the friction resistance between the wall of the cooling device and the extrudate becomes very high in long units. Drums can be added to such a cooling device, such as shown for example in EP 0 925 900 (A1), said drums have the primary task to pull the extrudate through the cooling device.

It is an object of the invention to provide a calibration and cooling method for flat foamed extrudates, in particular physically foamed extrudates with high cooling capacity and high throughput, in which an optimal surface quality of the foamed extrudate is reached.

### SUMMARY OF THE INVENTION

The problem is solved, in that the extrudate leaving the die is cooled first by a static vacuum cooling device and thereafter by cooling drums, whereby the extrudate is in contact with the cooling drum at least over a certain wrap angle.

Thereby the extrudate leaving the die is still in the plastic state and is guided first through a vacuum cooling device and is cooled thereafter by cooling drums.

A method for cooling a foamed ribbon-shaped extrudate strand is performed in a plant which comprises an extruder, a die, a vacuum cooling device and a cooling drum. In the extruder and mixing device arranged downstream of the extruder, a polymer melt containing a blowing agent is produced and the polymer melt containing the blowing agent is guided to the die. The die has an opening, through which a ribbon-shaped extrudate strand is produced. The ribbon-shaped extrudate strand foams in or after the die to a foamed ribbon-shaped extrudate strand. In particular, the foaming of the ribbon-shaped extrudate strand occurs immediately after leaving the die. The ribbon-shaped plastic foamed or foamable extrudate strand is cooled first by a static vacuum cooling device, so as to obtain a precooled formed ribbon-shaped extrudate strand. The foaming process is completed at latest after the vacuum cooling device. Thereafter the precooled foamed ribbon-shaped extrudate strand is guided over a cooling drum. The precooled foamed ribbon-shaped extrudate strand is in contact with the cooling drum over a wrap angle of at least 20°, such that the precooled foamed ribbon-shaped extrudate strand is cooled.

The fluid stream flowing through the vacuum cooling device containing a polymer with a blowing agent and being at least partially foamed is referred to as extrudate or an extrudate strand, as soon as it has left the extruder die. The fluid flow in the extruder or in a mixing device downstream of the extruder is referred to as a polymer melt containing a blowing agent. The polymer melt containing a blowing agent is obtained by addition of a blowing agent to a polymer melt. Physical blowing agents can be added in or after the extruder in a mixing device arranged downstream of the extruder. The mixing device is arranged upstream of the die, such that the die is fed with a polymer melt containing a physical blowing agent.

If a chemical blowing agent is used, it can be added to the polymer before or during the melting process in the extruder in addition to the options mentioned already in connection with physical blowing agents.

According to an embodiment a first cooling drum can be foreseen, which is in contact with a first lateral side of the precooled foamed ribbon-shaped extrudate strand, such that the first lateral side of the precooled foamed ribbon-shaped extrudate strand is cooled, whereby a single-sided cooled foamed ribbon-shaped extrudate strand is obtained.

A second cooling drum can be foreseen, which is in contact with a second lateral side of the single-sided cooled foamed ribbon shaped extrudate such that the second lateral side of the single-sided cooled foamed ribbon shaped extrudate strand is cooled, whereby a double-sided cooled foamed ribbon shaped extrudate strand is obtained.

The ribbon-shaped extrudate strand is in an embodiment foamed by means of a physical blowing agent. A preferred physical blowing agent is carbon dioxide, nitrogen or other inert gas.

A plant for cooling a foamed ribbon-shaped extrudate strand comprises an extruder, a die and a cooling drum. The extruder or a mixing device arranged downstream of the extruder comprises a metering device for a blowing agent, such that a polymer melt containing the blowing agent is obtainable. The polymer melt containing the blowing agent is transportable through the extruder and optionally further pumps in the direction of the die. When foaming with chemical blowing agents, the chemical blowing agent is typically fed together with the polymer to the extruder and is dissolved in the extruder or a subsequent mixing device. The die has an opening, by which a ribbon-shaped extrudate strand is obtainable. The ribbon-shaped extrudate strand is foamable in or after the die to a foamed ribbon-shaped extrudate strand. That means that the ribbon-shaped extrudate strand is transformable through expansion of the blowing agent into a foamed ribbon-shaped extrudate strand. Thus, hollow spaces are formed in the ribbon-shaped extrudate strand which are filled with blowing agent. In particular the foaming can start just after the die. The foamed or foaming ribbon-shaped extrudate strand leaving the die is passed first through a static vacuum cooling whereby a precooled foamed ribbon-shaped extrudate strand is obtainable. The precooled foamed ribbon-shaped extrudate strand is guidable over a cooling drum. The precooled foamed ribbon-shaped extrudate strand in contact with the cooling drum for about a wrap angle of at least 20°.

In particular a first cooling drum can be foreseen, which is in contact with a first lateral side of the precooled foamed ribbon-shaped extrudate strand, such that the first lateral side of the precooled foamed ribbon-shaped extrudate strand is in contact with the cooling drum along a length section defined by the wrap angle, whereby a single-sided cooled foamed ribbon-shaped extrudate strand is obtainable.

According to an embodiment, a second cooling drum can be foreseen, which is in contact with a second lateral side of the single-sided cooled foamed ribbon shaped extrudate strand such that the second lateral side of the single-sided cooled foamed ribbon shaped extrudate strand is in contact with the second cooling drum over a longitudinal section defined by a wrap angle is cooled, whereby a double-sided cooled foamed ribbon shaped extrudate strand is obtained.

In particular a free space can exist between the die and the vacuum cooling device. A mostly unhindered foaming of the ribbon-shaped extrudate strand can occur in this free space. According to an embodiment, a gas nozzle element can be arranged in the free space.

Under free space, it is intended a section, in which the ribbon-shaped extrudate strand can be moved freely from fixed guiding elements, such as floors, walls or ceiling elements. The free space also allows for an effective thermal separation between the die and the vacuum cooling device. This has the advantage that the die has to be heated for an optimal processing of the polymer melt and the vacuum cooling device has to be cooled for solidifying the surface of the extrudate strand.

The vacuum cooling device can include at least two plate elements arranged one above the other and parallel to each other. In particular the plate elements can be laterally open. The vacuum cooling device can have a length of at most 0.5 m in feed direction of the extrudate strand. By the term feed direction of the extrudate strand it is intended the direction in which the ribbon-shaped extrudate strand leaving the die moves forward. The vacuum cooling device has such a small length because it is not necessary to discharge the entire heat by it, but a portion of the heat can be discharged over the cooling drums. In particular the vacuum cooling device has a length of at most 0.3 m in feed direction of the extrudate strand. One of the plate elements can be staggered relative to the second plate element.

The vacuum cooling device can be integrated as a retrofit solution into an extrusion line with existing drum assembly. That means the vacuum cooling device can be added to existing plants. In particular the quality of the extrudate can be increased. The quality of the foamed extrudate can be increased for example by providing a narrower cell size distribution. That means that in particular the cells of the foam in the interior of the foamed extrudate have a similar size. The quality of the foam can in particular be increased by a more even smooth surface of the extrudate strand.

### BRIEF DESCRIPTION OF THE DRAWINGS

In the following the inventive method is shown in an example. Thereby it is shown in

FIG. 1: the method according to the invention with a vacuum cooling device and a drum assembly of three drums,

FIG. 2: the method according to the invention with a plurality of vacuum cooling devices, a drum assembly of three drums and additional air nozzles,

FIG. 3: a sectional view through a vacuum cooling device,

FIG. 4: a sectional view through the precooled foamed ribbon shaped extrudate strand,

FIG. 5: a sectional view through a single-sided cooled foamed ribbon shaped extrudate strand.

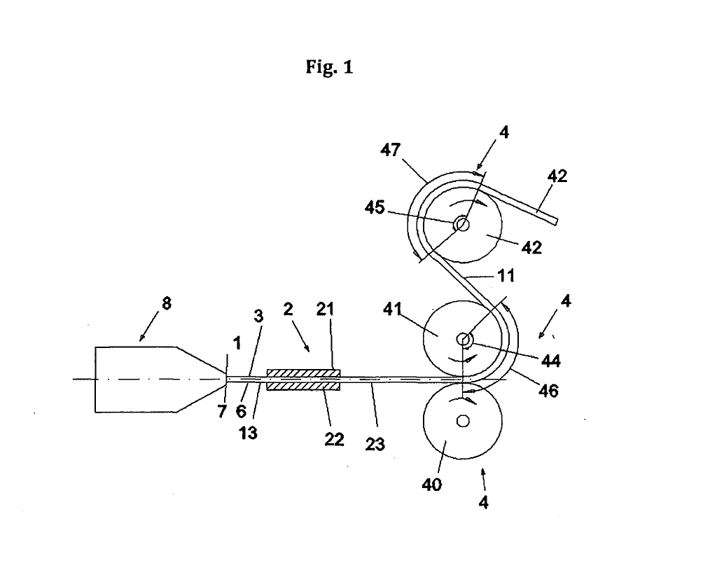

FIG. 1 shows a first embodiment of a plant for extrusion of a ribbon-shaped extrudate strand 1 containing a blowing agent. The extruder 8 for manufacturing the ribbon-shaped extrudate strand 3 is only shown schematically. The ribbon shaped extrudate strand 3 leaves the die 1, whereby the formation of foam occurs preferably downstream of the die, however also depending on the process in the die itself. The extrudate strand 3 is cooled after leaving the die 1 in a vacuum cooling device 2 and thereafter in an assembly of three drums 4. A free space 6 is foreseen between the die 1 and the vacuum cooling device 2 for preventing a deterioration of the cooling capacity of the vacuum cooling device by the die 1. The vacuum cooling device 2 consists of at least two parallel opposite in particular laterally open plates 21, 22.

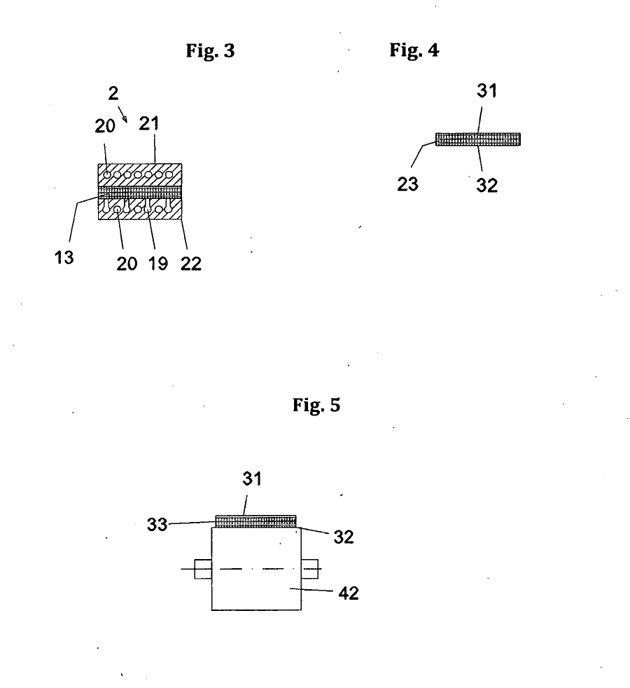

Channels 20 for a cooling fluid are foreseen in at least one of the plates 21, 22 and vacuum channels 19 in at least one of the plates for applying a vacuum as shown in FIG. 3. The vacuum channels 19 have a connection to the plate surface for the vacuum to become effective on the surface of the extrudate. The cooling is performed advantageously by liquids, such as water or thermal oil. The cooling liquid flows through the channels 20. The plates 21, 22 can have a surface structure and/or a coating to prevent a sticking of the extrudate to the surface of the plate. Advantageously the flat extrudate is bounded by two plates arranged oppositely to one another. It is possible to use single plates, or multiple plates or plates and pairs of plates in series arrangement.

Under vacuum it is intended a pressure below environment pressure. The extrudate 3 is calibrated in the vacuum cooling device 2. The application of a vacuum leads to a smoothing of the surface of the foamed or foamable extrudate, which is still in any case in the plastic state. The foaming process is advantageously concluded in the vacuum cooling device and the surface is stabilized. The vacuum cooling device is of a small length to keep friction forces small and to prevent detaching of the extrudate from the apparatus wall. It is possible because a portion of the cooling capacity is performed by the subsequent cooling drums of the drum assembly 4. The length of the vacuum cooling device 2 in direction of extrusion is at most 0.5 m, in particular at most 0.3 m.

Subsequent to the vacuum cooling device 2, the extrudate 3 is introduced into the assembly of three drums. The assembly of three drums has a first cooling drum 40, onto which the precooled foamed ribbon-shaped extrudate strand 23 is placed. A second cooling drum 41 is arranged above the first cooling drum 40. The cooling drum 40 forms a slit-like passage in combination with the cooling drum 41 such that the extrudate strand 23 is advantageously in contact on both sides and is thus pulled through the vacuum cooling device 2. Alternatively or in addition to the cooling drum 40, further pairs of drums can be foreseen in any location downstream of the vacuum cooling device 2 for pulling the extrudate strand, which is not shown in the drawings. The precooled foamed ribbon-shaped extrudate strand is in contact with the second cooling drum 41 along a longitudinal section 46, which forms a wrap angle 44, such that the precooled foamed ribbon-shaped extrudate strand 23 is in contact with the surface of the second cooling drum 41 over an angle of at least 20°, in particular at least 90°. The single-sided cooled foamed ribbon-shaped extrudate strand 33 is further cooled on the surface of the third cooling drum 42. The single-sided cooled foamed ribbon-shaped extrudate strand 33 is in contact with the surface of the third cooling drum 42 along a longitudinal section 47, which forms a wrap angle 45.

The wrap angle 45 is at least 20°, in particular at least 90°. That means the entire longitudinal section 47 which is in contact with the surface of the single-sided cooled foamed ribbon-shaped extrudate strand 33 can be used for the cooling.

Thus, the precooled foamed ribbon-shaped extrudate strand 23 has to be in contact with at least one cooling drum over a wrap angle of at least 20° to guarantee a sufficient cooling effect.

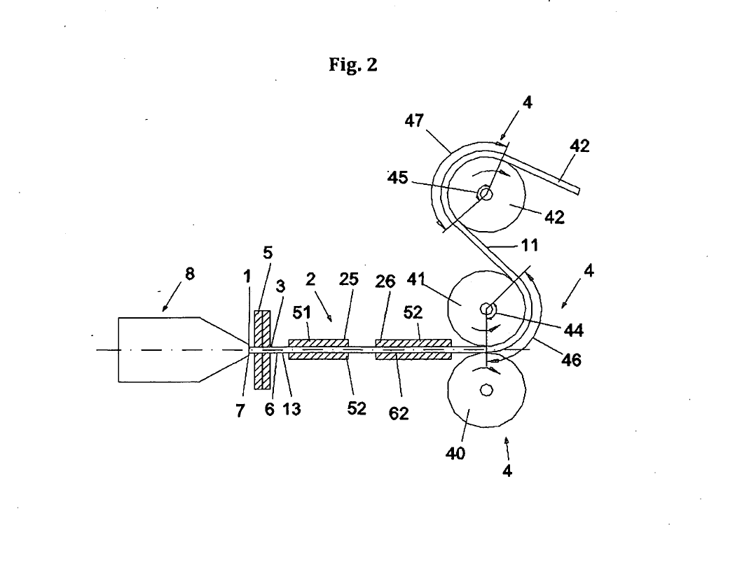

The assemblies of three drums as shown in FIG. 1 and FIG. 2 with the first cooling drum 40, the second and third cooling drums 41, 42 have been widely approved in practical arrangements. Thereby the extrudate strand contacts both cooling drums 41, 42 over an angle of at least 90°. If the cooling drums 41 and 42 have the same diameters, the wrap angle 44 can be substantially equal to the wrap angle 45. The wrap angle can be changed by changing the position of the cooling drums with respect to each other. The drum 40 can be configured as a cooling drum. In this drawing, a contact of the precooled foamed ribbon-shaped extrudate strand occurs only for a short time, such that the second lateral side of the precooled foamed ribbon-shaped extrudate strand is rarely cooled. The drum 40 is used for guiding of the precooled foamed ribbon-shaped extrudate strand 23.

FIG. 2 shows a variant of the device for performing the method according to the invention. An additional cooling is performed by gas nozzles 5. Such a gas nozzle is arranged in this embodiment in the region of the free space 6 between the die 1 and the vacuum cooling device 2. A gas flows from the gas nozzles 5 onto the surface of the extrudate 3. The gas can contain air. The gas nozzles 5 can be foreseen in any location. That means that the gas nozzles can be arranged instead of the position between the die 1 and the vacuum cooling device 2 also downstream of the vacuum cooling device 2, which is not shown in the drawings. The vacuum cooling device 2 consists according to FIG. 2 of a first vacuum cooling device 25 and a second vacuum cooling device 26. Each of the first and second vacuum cooling devices can consist of parallel open plates. The first vacuum cooling device 25 consists of the plates 51, 52 and the second vacuum cooling device consists of the plates 61, 62. A gas nozzle can also be arranged between the first vacuum cooling device 25 and the second vacuum cooling device 26, what is not shown in the drawing. If a plurality of vacuum cooling devices are used, one of the cooling devices can consist of one or two oppositely arranged cooled plates, which are not subjected to an evacuation. The vacuum cooling device can as a variant also be configured with closed sides.

The plates of the vacuum cooling device 2, 25, 26 according to any of the embodiments and the surfaces of the drums or cooling drums 40, 41, 42 of the drum assembly 4 can have a contoured shape, such as grooves or ribs.

FIG. 3 shows a sectional view of a vacuum cooling device 2. The foamed ribbon-shaped extrudate strand 13 runs between the first plate 21 and a second plate 22. The first plate 21 contains a plurality of cooling channels 20. The cooling channels 20 contain in the operative state a cooling fluid, in particular water or a thermal oil. The second plate contains also cooling channels 20 as well as additional vacuum channels 19. The vacuum channels 19 differ from the cooling channels such that they are open in the direction of the surface of the foamed ribbon-shaped extrudate strand.

FIG. 4 shows a sectional view through the precooled foamed ribbon shaped extrudate strand 23. The precooled foamed ribbon shaped extrudate strand 23 has a substantially rectangular cross-sectional area, which is delimited by a first lateral side 31, a second lateral side 32 from above and below. The first lateral side 31 has been precooled by the cooling device of the plate 32. The precooled foamed ribbon shaped extrudate strand 23 can be composed of a plurality of partial strands, what is not shown in the drawings.

FIG. 5 shows a sectional view through a single-sided cooled foamed ribbon shaped extrudate strand 33, which lies upon the second cooling drum 42. That means the second lateral side 32 of the single-sided cooled foamed ribbon shaped extrudate strand 33 rests upon the surface of the cooling drum 42. As a consequence a heat exchange occurs between the single-sided cooled foamed ribbon-shaped extrudate strand 33 and the cooling drum 42. The cooling drum is in particular rotatably supported, such that it moves together with the extrudate strand. The support and the drive of the cooling drum 42 are not shown.

The inventive cooling method is suitable for foamed mono-extrudates as well as multi-layer extrudates. Under a mono-extrudate an extrudate is intended, which consists of a single layer, thus a polymer or a polymer mixture, which is characterized by a substantially homogeneous distribution over the entire width and the entire height of the ribbon-shaped extrudate strand. The polymer or polymer mixture contains a cell structure, which is distributed substantially homogeneously in the polymer or polymer mixture.

Under a multi-layer extrudate, an extrudate is intended, which comprises more than a single layer, thus a plurality of polymers or polymer mixtures. Each of the layers containing a polymer or a polymer mixture extends over a portion of the width and/or a portion of the height of the ribbon-shaped extrudate strand and is characterized by a substantially homogeneous distribution within the layer. At least one of the polymers or polymer mixtures contains a cellular structure, which is distributed within the polymer or polymer mixture in a substantially homogeneous manner. For a multilayer configuration of the ribbon-shaped extrudate strand, some or all of the layers can be guided through the vacuum cooling device. Further layers can be laminated onto the mono-layer extrudate or multi-layer extrudate at any position downstream of the die 1 by means of an adhesion-promoting agent.

The method according to the invention is also suitable for a retrofit solution. A plurality of cooling devices for the manufacture of non-foamed flat extrudates are known in the prior art for producing a ribbon-shaped extrudate strand, in which the ribbon-shaped extrudate strand is guided over a drum assembly of three drums.

If foamed extrudates are processed in a cooling device according to the prior art, it is in many cases the cooling capacity of the drum assembly 4 which is limiting throughput. That means, the feed rate of the ribbon-shaped extrudate strand has to be maintained small enough to discharge the accumulated heat. The cooling capacity is substantially increased by retrofitting a vacuum cooling device for a method according to the invention together with an optimization of the surface quality occurring contemporaneously.

1) A method for cooling a foamed ribbon-shaped extrudate strand (3) is performed in a plant which comprises an extruder (8), a die (1), a vacuum cooling device (2) and a cooling drum, whereby in the extruder (8) or a mixing device arranged downstream of the extruder, a polymer melt containing a blowing agent is produced and the polymer melt containing the blowing agent is guided to the die (1), whereby the die has an opening (7), through which a ribbon-shaped extrudate strand (3) is produced which foams in or after the die (1) to a foamed ribbon-shaped extrudate strand (13) characterized in that the ribbon-shaped plastic foamed or foamable extrudate strand (13) is cooled first by a static vacuum cooling device (2, 25, 26), so as to obtain a precooled foamed ribbon-shaped extrudate strand (23) and the precooled foamed ribbon-shaped extrudate strand (23) is guided over a cooling drum (40, 41, 42) whereby the precooled foamed ribbon-shaped extrudate strand (23) is in contact with the cooling drum (41, 42) over a wrap angle of at least 20°, such that the precooled foamed ribbon-shaped extrudate strand (23) is cooled.

2) A method according to claim 1, whereby a first cooling drum (41) is foreseen, which is in contact with a first lateral side (31) of the precooled foamed ribbon shaped extrudate strand (23) such that the first lateral side (31) of the precooled foamed ribbon shaped extrudate strand (23) is cooled, whereby a single-sided cooled foamed ribbon shaped extrudate strand (33) is obtained.

3) A method according to claim 2, whereby a second cooling drum (42) is foreseen, which is in contact with a second lateral side (32) of the single-sided cooled foamed ribbon shaped extrudate strand (33) such that the second lateral side (32) of the single-sided cooled foamed ribbon shaped extrudate strand (33) is cooled, whereby a double-sided cooled foamed ribbon shaped extrudate strand (43) is obtained.

4) Method according to claim 1, whereby the ribbon-shaped extrudate strand (3) is foamed by means of a physical blowing agent.

5) A plant for cooling a foamed ribbon-shaped extrudate strand (13), which comprises an extruder (8), a die (1) and a cooling drum (40, 41, 42) and a polymer melt, whereby the extruder (8) or a mixing device arranged downstream of the extruder comprises a metering device for a blowing agent, such that a polymer melt containing the blowing agent is obtainable, whereby the polymer melt containing the blowing agent is transportable through the mixing device in the direction of the die (1) whereby the die (1) has an opening, by which a ribbon-shaped extrudate strand (3) is obtainable, which is foamable in or after the die to a foamed ribbon-shaped extrudate strand (13) characterized in that the foamed ribbon-shaped extrudate strand (13) leaving the die (1) is passed through a static vacuum cooling (2, 25, 26) whereby a precooled foamed ribbon-shaped extrudate strand (23) is obtainable and the precooled foamed ribbon-shaped extrudate strand (23) is guidable over a cooling drum (40, 41, 42) whereby the precooled foamed ribbon-shaped extrudate strand (23) in contact with the cooling drum (41, 42) for about a wrap angle (44) of at least 20°.

6) A plant according to claim 5, whereby a first cooling drum (41) is foreseen, which is in contact with a first lateral side of the precooled foamed ribbon-shaped extrudate strand (23), such that the first lateral side of the precooled foamed ribbon-shaped extrudate strand is in contact with the cooling drum along a length section (46) defined by the wrap angle (44), whereby a single-sided cooled foamed ribbon-shaped extrudate strand (33) is obtainable.

7) A plant according to claim 6, whereby a second cooling drum (42) is foreseen, which is in contact with a second lateral side (32) of the single-sided cooled foamed ribbon shaped extrudate strand (33) such that the second lateral side of the single-sided cooled foamed ribbon shaped extrudate strand (33) is in contact with the second cooling drum (42) over a longitudinal section (47) defined by a wrap angle (45) is cooled, whereby a double-sided cooled foamed ribbon shaped extrudate strand (43) is obtained.

8) A plant according to claim 5, whereby a free space (6) exists between the die (1) and the vacuum cooling device (2).

9) A plant according to claim 5, whereby the vacuum cooling device (2, 25, 26) includes at least two plate elements (21, 22, 51, 52, 61, 62) arranged one above the other and parallel to each other.

10) A plant according to claim 9, whereby the plate elements (21, 22, 51, 52, 61, 62) are laterally open.

11) A plant according to claim 5, whereby the vacuum cooling device (2, 25, 26) has a length of at most 0.5 m in feed direction of the extrudate strand.

12) A plant according to 5, whereby the vacuum cooling device (2, 25, 26) has a length of at most 0.3 m in feed direction of the extrudate strand.

13) A plant according to claim 8, whereby a gas nozzle element (5) is arranged in the free space (6).

14) A plant according to claim 9, whereby one of the plate elements (21, 51, 61) is arranged in a staggered configuration with respect to the second plate element (22, 52, 62).

15) A plant according to claim 5, whereby the vacuum cooling device (2) is integrated as retrofit solution for an extrusion line with an existing assembly of cooling drums (4).
